(19) United States
(12) Patent Application Publication
(10) Pub. No.: US 2009/0141869 A1
(43) Pub. Date: Jun. 4, 2009

(54) APPARATUS AND METHOD FOR COMPARING SIGNAL STRENGTH IN A SPEAKERPHONE SYSTEM

(76) Inventors: Weifeng Wang, Shanghai (CN); Caogang Yu, Shanghai (CN)

Correspondence Address: PERKINS COIE LLP;PATENT-SEA, P.O. BOX 1247, SEATTLE, WA, 98111-1247, US

(21) Appl. No.: 12/262,098

(22) Filed: Oct. 30, 2008

(30) Foreign Application Priority Data
Nov. 30, 2007 (CN) 200710094362.1

(51) Int. Cl. H04M 1/24

(52) U.S. Cl. 379/27.01

(57) ABSTRACT

A method and system for comparing signal strength in a speakerphone system is disclosed. The system is configured to operate in a half-duplex mode, where the direction of communication is determined by comparing signals based on the transmit input signal and the receive input signal. The system estimates and compares the transmit data signal strength and the receive data signal strength. The system then controls a transmit switch and a receive switch to selectively enable transmission based on the comparison. The system also reconfigures the estimation components based on the comparison of the estimated signal strengths. In one implementation, the system estimates the signal envelopes for the inputs and the envelopes of the noise components of the inputs. The system uses the estimates to calculate the data component of the input signals by subtracting the noise envelope from the total signal. A controller compares the strength signals to determine the current state of the system. If one signal is stronger than the other, the controller switches to that state and blocks the weaker signal. The system uses the states to configure the system components.

### CROSS-REFERENCE TO RELATED APPLICATIONS

This application claims priority to Chinese Patent Application No. 200710094362.1, filed Nov. 30, 2007, the disclosure of which is incorporated herein in its entirety.

### BACKGROUND

In the business world, speakerphones are very useful because they allow a group of people at a single location to participate in a telephone call. However, the design of these telephones causes problems not present in a standard telephone handset. In particular, speakerphones lack the physical separation between speaker and microphone present in a typical handset. In a speakerphone, the microphone and speaker are next to each other and active simultaneously. This can result in audio echo, where the sound from the speaker is received by the microphone and transmitted back through the telephone line. This can be annoying to listeners on a remote telephone and can even make the speakerphone useless in extreme cases. More generally, the microphone in a speakerphone receives significant amounts of background noise in addition to the useful signal, which can also be annoying to listeners on the remote telephone. Existing solutions to this problem are often error-prone or otherwise ineffective. Therefore, it would be useful to have a way to mask background noise and audio echo without causing additional errors in the audio.

### BRIEF DESCRIPTION OF THE DRAWINGS

FIG. 1 illustrates an environment in which a signal strength comparison system operates.

FIG. 2 illustrates a block diagram of a circuit suitable for implementing the signal strength comparison system.

FIG. 3 illustrates a block diagram of a circuit suitable for estimating transmit and receive strength signals.

FIG. 4 illustrates a flowchart of a process for implementing the signal strength comparison system.

FIGS. 5A-C are flowcharts showing processes for implementing the evaluation and change of state in the controller.

### DETAILED DESCRIPTION

A method and system for comparing signal strength in a speakerphone system is disclosed (hereinafter referred to as the “signal strength comparison system” or the “system”). The system is configured to operate in a half-duplex mode, where the direction of communication is determined by comparing signals based on the transmit input signal and the receive input signal. The system estimates and compares the transmit data signal strength and the receive data signal strength. The system then controls a transmit switch and a receive switch to selectively enable transmission based on the comparison. The system also reconfigures the estimation components based on the comparison of the estimated signal strengths.

In some embodiments, the system first estimates the signal envelopes for the received signal and the transmitted signal. It then uses the estimated signal envelopes to estimate the noise envelopes for the received signal and the transmitted signal. The system then uses the estimates to calculate the data component of the input signals by subtracting the noise envelope from the total signal. A controller compares the strength signals to determine the current state of the system. If one signal is stronger than the other, the controller switches to that state and blocks the weaker signal. If both signals are weak, the controller enters IDLE state, where it blocks both signals. The system uses the states to configure the system components. For example, the envelope estimators use various infinite impulse response (IIR) filters. The system varies the time constant for the IIR filters depending on whether it is in IDLE, TRANSMIT, or RECEIVE state. The system also reconfigures the noise estimators depending on the current state.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

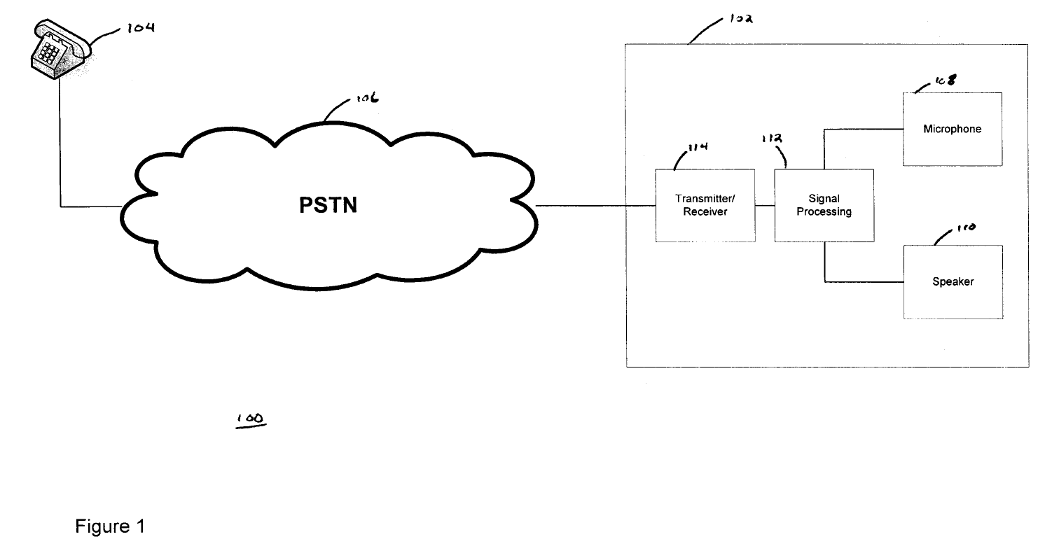

FIG. 1 illustrates an environment 100 in which a signal strength comparison system operates. The environment 100 includes a speakerphone 102 which has internal components that are described in greater detail below. The environment 100 also includes a remote telephone 104, which may be any type of telephone, such as a standard landline telephone, a speakerphone, or a wireless or cellular telephone. The telephones are connected to a telephone network 106, which provides a communications channel between the telephones. In the embodiment of FIG. 1, the telephone network 106 is the public switched telephone network (PSTN), but the speakerphone 102 could also connect to a private branch exchange (PBX) or to a packet-switched network providing Voice over Internet Protocol (VoIP) services. Similarly, the speakerphone 102 and the remote telephone 104 could be connected to the telephone network 106 through either a wired or wireless connection.

As shown in FIG. 1, the speakerphone 102 contains a microphone 108 and a speaker 110. The microphone 108 receives sound from the environment, including voices, and converts it to an electrical signal. Similarly, the speaker 110 converts the received signal into sound. The speakerphone 102 also contains a signal processing component 112, which executes various types of signal processing, such as filtering and automatic gain control (AGC). The signal strength comparison system may be implemented at this stage in combination with these other signal processing techniques.

The speakerphone 102 also includes a transmitter/receiver component 114 that connects to the telephone network 106. The transmitter/receiver component 114 provides the functionality to send and receive voice signals between the speakerphone 102 and the telephone network 106. In the case of a connection to the PSTN, the transmitter receiver component 114 handles dialing and transmitting the audio signal. For a VoIP system, the transmitter/receiver component 114 manages the connection to the packet-based network and transmits the audio data in packet form.

The different configuration of the speakerphone 102 leads to new challenges not present in a regular telephone. The microphone 108 must be sufficiently sensitive to detect sound from all users, some of whom may be relatively distant from the speakerphone. Because of this, the speakerphone receives more background noise than a standard telephone. Additional problems arise because the microphone and the speaker are in close proximity. If the gain of the system is greater than one, there can be significant acoustic echo as the microphone picks up sound received from the remote telephone 104 and transmits it back to the remote telephone 104 at a slight delay.

A standard solution to the echo problem is to use a half-duplex system, rather than a full-duplex system, in the speakerphone 102. In the half-duplex configuration, the speakerphone determines which side of the conversation is talking at a given moment and enables the components necessary to forward that signal while blocking the other. For example, if the user of the speakerphone 102 is speaking, the system deactivates the telephone's receiver and activates its transmitter. The system does the opposite if it determines that the user of the remote telephone 104 is speaking.

Previous systems for determining signal strength use analog components to estimate the power level of the transmit signal and the receive signal. These systems then compare the estimated power levels and configure the speakerphone to pass the signal having the higher power level. However, this method fails if one of the signals has a strong noise component. Because the power estimation measures the envelope for the whole signal, it incorporates both data and noise components. If a signal has a large noise component, the system might select that signal to pass even though the data component is larger for the other signal. For example, consider a case where the transmit and receive signals have the following amplitudes:

| | Transmit | Receive |
|---|---|---|
| Data | 1 | 2 |
| Noise | 11 | 2 |

In this example, the system should select the receive signal because the data component of the receive signal is greater than the data component of the transmit signal. However, the prior art system would select the transmit signal because its total signal amplitude (data plus noise) is greater than the total signal amplitude of the receive signal. Thus, in this example, the prior art system actually passes the signal with the higher noise level and the lower useful signal.

The prior art has other problems, as well. For example, speakerphone systems that attempt noise estimation generally use an IIR filter with a large time constant to estimate the background noise envelope. However, this method is inaccurate when the noise duration is relatively short. A further problem is that even when there is only a receive signal, the transmit signal can be very large because of acoustic echo. This transmit signal is slightly delayed from the receive signal and can overwhelm the receive signal at the end of the receive signal.

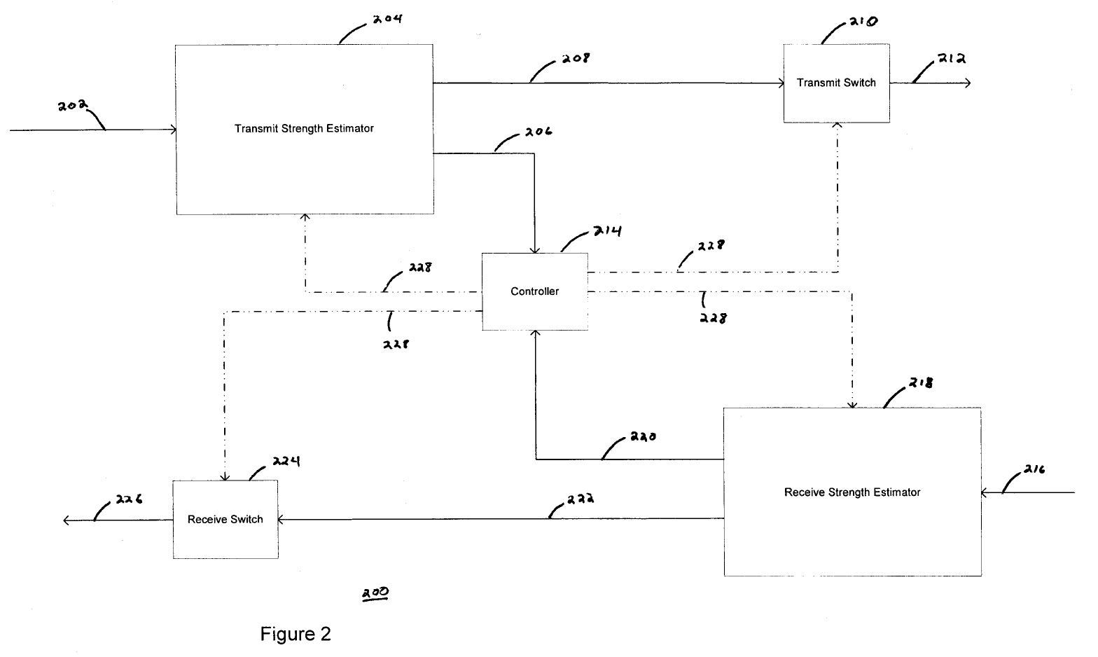

FIG. 2 illustrates a block diagram of a circuit 200 suitable for implementing the signal strength comparison system. An application specific integrated circuit (ASIC), discrete components, a mixed signal integrated circuit, and/or the like may be employed in circuit 200. Circuit 200 may also be implemented as modules of a Digital Signal Processing (DSP) board. Circuit 200 may also include analog circuitry, digital circuitry, and/or mixed analog/digital circuitry. Signals between modules of the circuit 200 may be transmitted as electrical signals or as variables passed between modules of a DSP board.

The circuit 200 receives a transmit input signal 202 from the microphone 108 or from another audio input component connected to the speakerphone. As noted above, the transmit input signal 202 has a data component and a noise component. The transmit input signal 202 is provided to the transmit strength estimator 204, which extracts a transmit data strength signal 206. The transmit data strength signal 206 is an estimate of the data component of the transmit input signal 202. The transmit data strength signal 206 is provided to the controller 214. The transmit strength estimator 204 can be configured by a control signal 228 received from the controller 214. The transmit strength estimator 204 also provides an intermediate transmit signal 208 to the transmit switch 210. The intermediate transmit signal 208 may be equal to the transmit input signal 202 or may be a filtered or otherwise processed version of the transmit input signal 202. The transmit switch 210 is configured to selectively pass or block the transmit signal according to a control signal 228 received from the controller 214. The transmit switch 210 outputs the transmit output signal 212, which is generally equal to either the intermediate transmit signal 208 or to zero, depending on whether the control signal 228 indicates that the signal should be passed or blocked.

The circuit 200 also receives a receive input signal 216, which is transmitted from the remote telephone 106 through the telephone network 104 and processed initially by the transmitter/receiver component 114. The receive input signal 216 is provided to the receive strength estimator 218, which extracts a receive data strength signal 220, which is an estimate of the useful signal component of the receive input signal 212. The receive strength estimator 218 provides the receive data strength signal 220 to the controller 214. The receive strength estimator 218 may also be configured by a control signal 228 received from the controller 214. The receive strength estimator 218 provides an intermediate receive signal 222 based on the receive input signal 212 to the receive switch 224. The receive switch 224 is also configured to selectively pass or block the receive signal according to a control signal 228 from the controller 214. The receive switch 224 outputs a receive output signal 226.

The controller 214 evaluates the input strength estimations and reconfigures the circuit 200 based on the evaluation. The controller 214 operates as a finite state machine (FSM) with three states: TRANSMIT, RECEIVE, and IDLE. The meanings of each state and the associated configurations are discussed in detail below. In general, the controller 214 selectively enables and disables the transmit switch 210 and the receive switch 224 based on the state. The controller 214 also varies the configuration of the transmit strength estimator 204 and the receive strength estimator 218 depending on state. For example, in some embodiments, the estimators 204 and 218 use IIR filters with configurable time constants. In these embodiments, the components modify the time constants in response to the change in state.

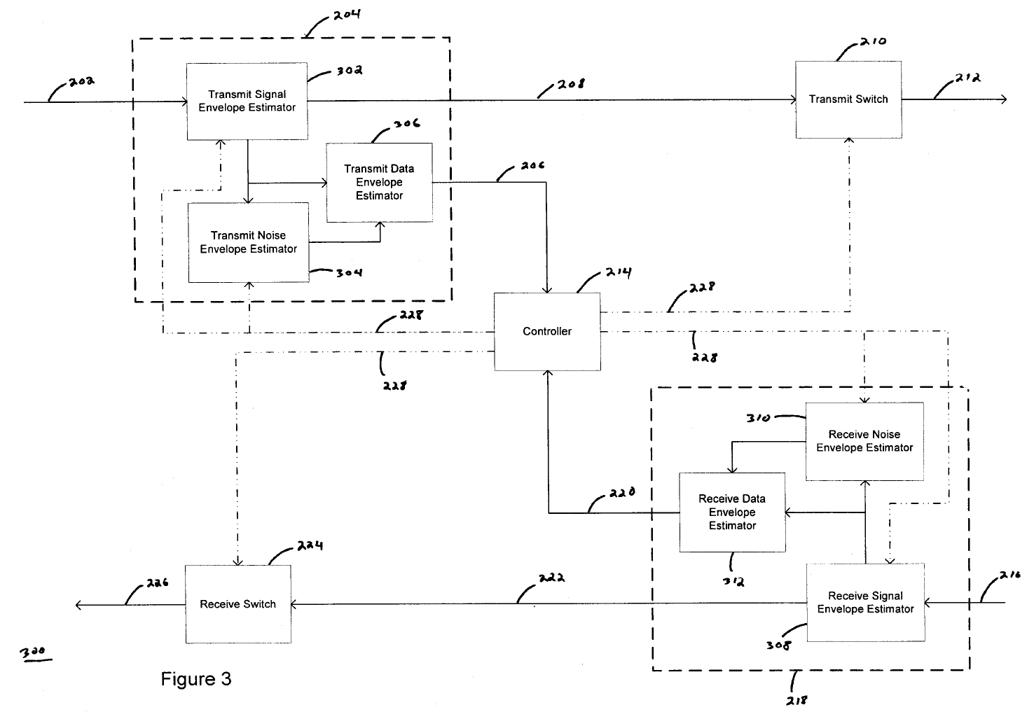

FIG. 3 illustrates a block diagram of a circuit 300 suitable for estimating transmit and receive strength signals. The block diagram of FIG. 3 shows an implementation of component modules of the transmit strength estimator 204 and the receive strength estimator 218. The transmit input signal 202 is received by the transmit signal envelope estimator 302, which estimates the signal envelope of the transmit input signal 302 (i.e. including both data and noise components). In one embodiment, the transmit signal envelope estimator 302 uses an IIR filter with a configurable time constant to estimate the transmit signal envelope. In this embodiment, the controller 214 adjusts the time constant through a control signal 228 connected to the transmit signal envelope estimator 302. The estimated transmit signal envelope is provided to the transmit switch 210, which is configured by the controller 214 as discussed above. In some configurations, the transmit switch 210 and the receive switch 224 are implemented as attenuators configured to selectively pass a signal at full strength or to attenuate the signal to a low value.

The transmit signal envelope estimator 302 provides the estimated transmit signal envelope to the transmit noise envelope estimator 304, which estimates the noise component of the transmit signal. The estimated signal envelope and the estimated noise envelope are then provided to the transmit data envelope estimator 306, which generates the transmit data envelope by subtracting the estimated transmit noise envelope from the estimated transmit signal envelope. The transmit useful signal envelope is output as the transmit data strength signal 206, which is provided to the controller 214.

The receive component of the circuit 200 is similarly configured. The receive input signal 216 is provided to the receive signal envelope estimator 308, which estimates the signal envelope of the receive input signal 216. The estimated signal envelope is provided to the receive switch 224 and to the receive noise envelope estimator 310, which estimates the noise envelope of the signal. The receive data envelope estimator 312 then generates the receive data envelope by subtracting the estimated receive noise envelope from the estimated receive signal envelope. The receive noise envelope is then output as the receive signal strength signal 220, which is provided to the controller 214.

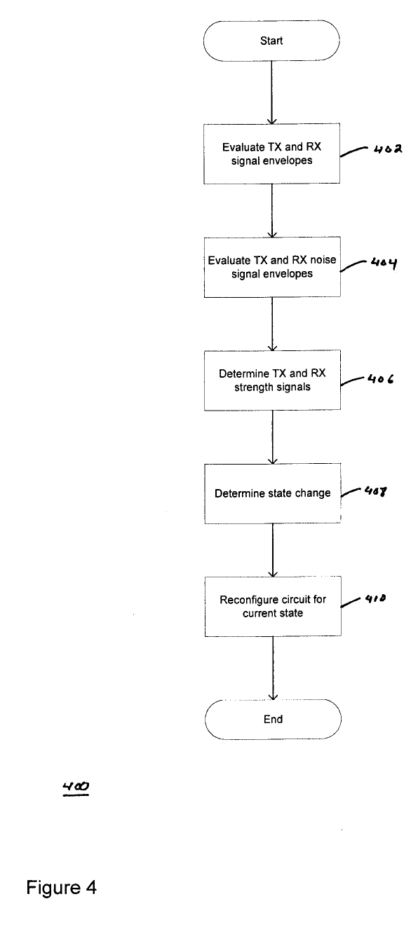

FIG. 4 illustrates a flowchart of a process 400 for implementing the signal strength comparison system. The system begins processing in block 402, where it evaluates the signal envelopes for the transmit and receive signals. In some embodiments, this is done using an envelope IIR filter with two time constants. Envelope IIR filters are well-known in the art and will only be discussed briefly here. The envelope IIR filter (an envelope follower) receives a signal with a varying amplitude around a particular frequency and outputs a DC signal that represents the amplitude envelope of the input signal. The time constant of the signal determines how the filter responds to transient signals. If the time constant is high, the output signal shows less effect from transient signals but is slower to respond to actual signal changes. As stated above, the controller 214 may reconfigure the time constants of the transmit signal envelope estimator 302 and the receive signal envelope estimator 308 according to the current state of the system.

After calculating the signal envelopes, the system proceeds to block 404, where it evaluates the transmit and receive noise envelopes. The noise envelope is estimated by determining the minimum value for the signal envelope over a specified time window and applying an IIR filter to the resulting signal. The controller 214 may also reconfigure the noise envelope estimators 304 and 310 by changing the length of the time window used to determine the minimum value.

After the system calculates the noise signal envelopes, it proceeds to block 406, where the transmit data envelope estimator 306 and the receive data envelope estimator 312 evaluate the transmit and receive data strength signal. The strength signal, SS(t), is calculated according to the following equation:

$$SS ( t ) = \{ \begin{matrix}S ( t ) - N ( t ) , & if S ( t ) > N ( t ) \\ 0 , & if S ( t ) \leq N ( t ) ,\end{matrix}$$

where S(t) is the signal envelope and N(t) is the noise envelope. Thus, if the signal envelope is greater than the noise envelope, the strength signal is calculated as the difference between the two. If the noise envelope is greater, the strength signal is set to zero.

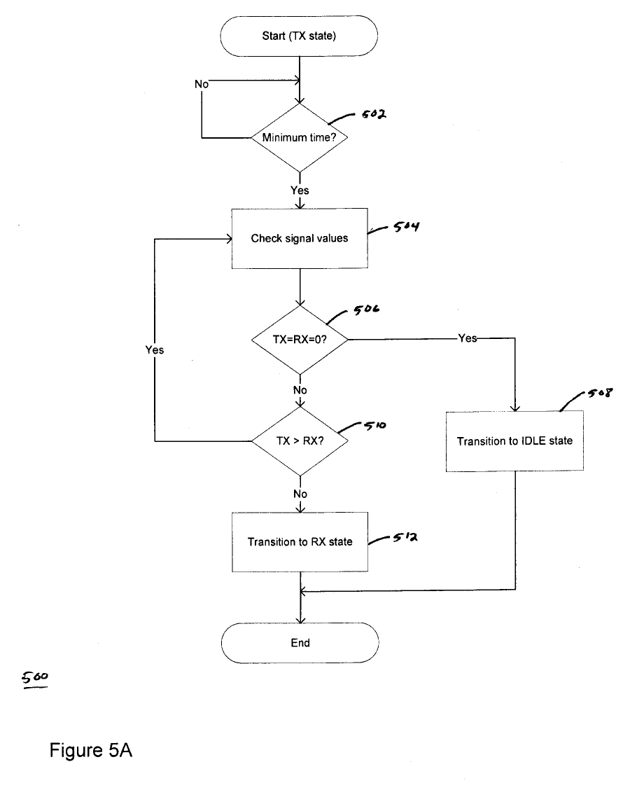

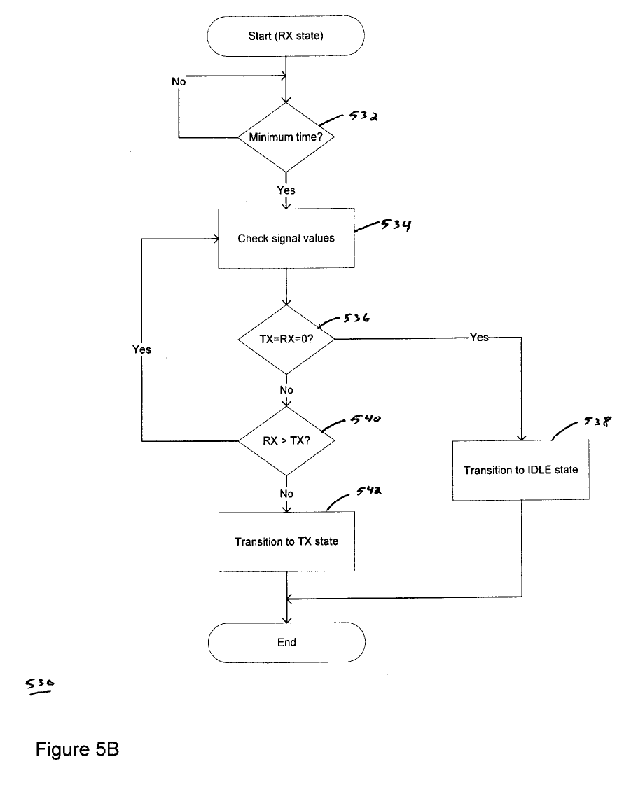

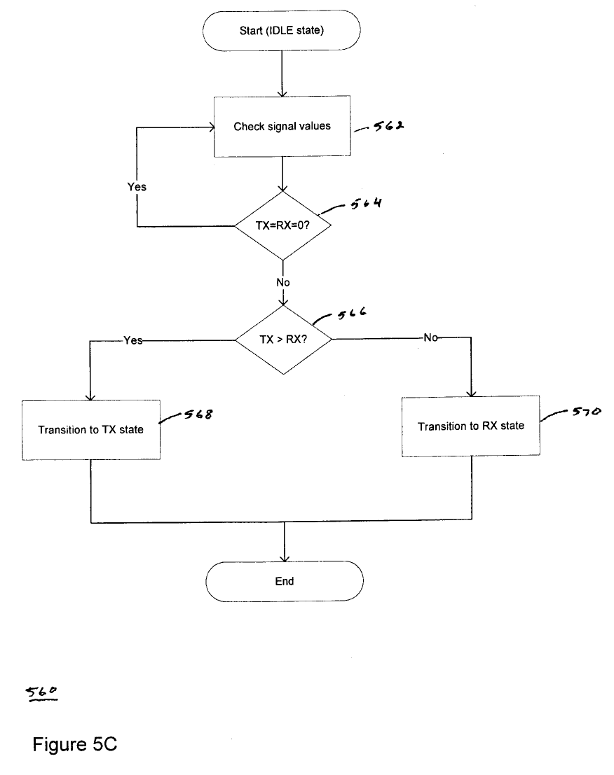

After the system determines the useful signal envelopes, it proceeds to block 408, where it determines if the calculated signal strengths indicate a state change. The system determines this according to the processes described in FIGS. 5A-C. Proceeding to block 410, the controller 214 re configures the system according to the current state as described below. Of course, if the state did not change, the system skips this step and does not reconfigure the system.

As stated above, the system has three operating states: TRANSMIT, RECEIVE, and IDLE. In the TRANSMIT state, the controller 214 has determined that the transmit signal is stronger and signals the switches to pass the transmit signal and block the receive signal. When the system is in TRANSMIT state, it also configures the transmit SEE component to have a long time constant and the receive signal envelope estimator 302 to have a short time constant. In this configuration, the transmit signal envelope estimator 304 is relatively unresponsive to transient signals, while the receive signal SEE component 316 is more sensitive to transient signals. This configuration is used so that a transmitting system is not significantly affected by momentary changes in transmit signal strength, which may be from a minor change in volume, while being responsive to changes in the receive signal that might indicate a useful signal.

In the RECEIVE state, the controller 214 has determined that the receive signal is stronger. Thus, the controller 214 signals the switches to pass the receive signal and block the transmit signal. The controller also sets the time constant for the receive signal envelope estimator 308 to be high and the time constant for the transmit signal envelope estimator component 302 to be low.

In the IDLE state, the system has determined that no useful signal is being generated by either part of the system. In this state, the controller 214 configures the switches to block both the transmit and receive signals. The controller 214 also configures the transmit signal envelope estimator 304 and the receive signal envelope estimator 316 to be sensitive to new input signals by configuring both with short time constants.

The system also changes the time window for the noise envelope estimator 306 and 318 depending on the current state. As discussed above, the noise envelope estimators determine the noise envelope of a signal by using the lowest value of the signal over a specified time window. When the system is in IDLE mode, the controller 214 sets the time window to a small value. As with the signal envelope estimators, this configuration makes the system more sensitive to incoming data, even at the risk of interpreting spurious noise as signal. However, when the system is in the TRANSMIT or RECEIVE states, it uses a larger time window to determine the noise envelope. As an example, the short interval might be in a range from 64 ms to 512 ms, while a corresponding long interval might be in the range from 256 ms to 2048 ms.

FIGS. 5A-5C are flowcharts showing processes 500, 530, and 560 for implementing the evaluation and change of state in the controller. FIG. 5A shows a process 500 implemented by the system in the TRANSMIT state. The system begins processing at block 502, where it evaluates whether it has spent enough time at the current state. The system can be configured to always dwell in a certain state for a minimum period before a change in state is possible. This helps to avoid short switches between states based on transient signals. For example, the system may be configured to always stay in the TRANSMIT state for at least 64 ms. Thus, in block 502, the system first checks if it has spent sufficient time in the state. If the minimum time has not passed, the system loops until sufficient time has passed. After sufficient time has passed, the system proceeds to block 504, where it receives the current values of the transmit data strength signal 206 and the receive data strength signal 220.

After the system receives the input values, it proceeds to decision block 506, where it determines if both signals are zero. If both signals are zero, the system determines that the signals have no data component and proceeds to block 508, where it transitions to IDLE mode. In some embodiments, the system attempts to avoid unnecessary transitions by requiring that a certain condition be present for a minimum time before making the transition. For example, the system could be configured to transition to IDLE mode only if the transmit data strength signal 206 and the receive data strength signal 220 are equal to zero for more than 16 ms.

If at least one of the signals is not equal to zero, the system proceeds to block 510, where it compares the transmit data strength signal 206 to the receive data strength signal 220. If the transmit data strength signal 206 is greater, the system does not need to transition to a different state, so it returns to block 504, where it repeats checking signal values. If the transmit useful signal envelope is less than the received useful signal envelope, the system proceeds to block 512, where it transitions to the RECEIVE state. As with block 506, in some embodiments the system is configured to transition to a new state only if the transition condition applies for a minimum period of time, such as 16 ms.

One skilled in the art will appreciate that many system parameters could be varied either at manufacture time or at runtime. For example, a designer might set the time constants for the signal envelope estimators based experimental determination, theoretical evaluation, or a combination. The same could apply to the noise envelope estimator parameters or the minimum time periods for state transition. Alternatively, the system could include a feedback component (not shown) allowing the system to adaptively vary these parameters according to the system output.

FIG. 5B shows a process 530 implemented by the system in the RECEIVE state. The system begins processing in block 532, where it determines if it has been in the RECEIVE state for a minimum time period. After the minimum time period has passed, the system proceeds to block 534, where it receives the current values of the transmit data strength signal 206 and the receive data strength signal 220. In decision block 536, the system determines if the signals are both equal to zero. If the signals are equal to zero, the system proceeds to block 538, where it transitions to the IDLE state. Otherwise, the system proceeds to decision block 540, where it determines if the receive data strength signal 220 is greater than the transmit data strength signal 206. If the receive data strength signal 220 is greater, the system stays in the RECEIVE state and returns to block 534 to repeat the processing steps. If the transmit data strength signal 206 is greater, the system proceeds to block 542, where it transitions to TRANSMIT mode. As with the process 500 in FIG. 5A, the system may be configured to change states only if a transition condition applies for a minimum period of time.

FIG. 5C shows a process 560 implemented by the system in the IDLE state. When operating in the IDLE state, the system is configured to be most sensitive to signal changes. Thus, the controller 310 is configured to exit the IDLE state as soon as a useful signal is received, without any requirement to wait in the state for a minimum time period. The system begins processing at block 562, where it receives the current values of the transmit data strength signal 206 and the receive data strength signal 220. The system then proceeds to decision block 564, where it determines if the signals are both equal to zero. If the signals are equal to zero, the system remains in the IDLE state and returns to block 562 to repeat the processing steps. Otherwise, the system proceeds to decision block 566, where it determines if the transmit data strength signal 206 is greater than the receive data strength signal 220. If the transmit data strength signal 206 is greater, the system proceeds to block 568, where it transitions to the TRANSMIT state. If the receive data strength signal 220 is greater, the system proceeds to block 670, where it transitions to the RECEIVE state.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. An apparatus for comparing signal strength in a speakerphone system, comprising:
a transmit strength estimator configured to receive a transmit input signal and a transmit configuration control signal and to provide a transmit data strength signal based at least in part on the transmit input signal and the transmit configuration control signal;
a receive strength estimator configured to receive a receive input signal and a receive configuration control signal and to provide a receive data strength signal based at least in part on the receive input signal and the receive configuration control signal; and
a controller configured to receive the transmit data strength signal and the receive data strength signal and to provide the transmit configuration control signal based at least in part on the transmit data strength signal and the receive data strength signal and the receive configuration control signal based at least in part on the transmit data strength signal and the receive data strength signal.

2. The apparatus of claim 1, wherein the transmit input signal has a data component and a noise component and wherein the transmit data strength signal is based at least in part on the data component.

3. The apparatus of claim 1, wherein the transmit input signal has a data component and a noise component and wherein the transmit data strength signal is determined by subtracting the noise component from the transmit input signal.

4. The apparatus of claim 1, wherein the receive input signal has a data component and a noise component and wherein the receive data strength signal is determined by subtracting the noise component from the receive input signal.

5. The apparatus of claim 1, further comprising a transmit switch configured to receive a transmit output control signal and the transmit input signal and to generate a transmit output signal based at least in part on the transmit input signal and the transmit output control signal.

6. The apparatus of claim 1, wherein the transmit input signal has a data component and a noise component and wherein the transmit strength estimator comprises:
a transmit input strength estimator configured to calculate a strength of the data component and the noise component;
a transmit noise strength estimator configured to calculate a strength of the noise component; and
a subtractor configured to calculate a difference between the strength of the data component and the noise component and the strength of the noise component, wherein the difference is provided as the transmit data strength signal.

7. The apparatus of claim 1, wherein the transmit strength estimator, the receive strength estimator, and the controller are implemented as digital signal processor modules.

8. The apparatus of claim 1, further comprising:
a transmit switch configured to receive a transmit output control signal and the transmit input signal and to generate a transmit output signal based at least in part on the transmit input signal and the transmit output control signal;
a receive switch configured to receive a receive output control signal and the receive input signal and to generate a receive output signal based at least in part on the receive input signal and the receive output control signal,
wherein the controller is further configured to generate the transmit output control signal to control the transmit switch to substantially attenuate the transmit input signal and to generate the receive output control signal to control the receive switch to substantially attenuate the receive input signal, if the transmit data strength signal and the receive data strength signal are both substantially equal to zero.

9. The apparatus of claim 1, wherein the receive strength estimator further comprises:
a receive noise estimator configured to extract a noise component of the receive input signal, wherein extracting a noise component comprises determining the minimum value of the receive input signal during a specified time period, and
a subtractor configured to determine the difference between the receive input signal and the noise component of the receive input signal, wherein the difference is provided as the receive data strength signal.

10. The apparatus of claim 1, wherein the receive strength estimator comprises an infinite impulse response filter having a configurable time constant and wherein the receive strength estimator is configured to configure the time constant in response to the receive configuration control signal.

11. An apparatus for comparing signal strength in a speakerphone system, comprising:
a transmit strength estimator configured to extract a transmit data strength based at least in part on a data component strength of a transmitter input and to reconfigure the extraction based at least in part on a transmit control input;
a receive strength estimator configured to extract a receive data strength based at least in part on a data component strength of a receiver input and to reconfigure the extraction based at least in part on a receive control input; and
a controller configured to compare the transmit data strength and the receive data strength and to provide the transmit control input and the receive control input based at least in part on the relative sizes of the transmit data strength and the receive data strength.

12. The apparatus of claim 11, wherein extracting the transmit data strength comprises subtracting the noise component from the transmit input signal.

13. The apparatus of claim 11, wherein the transmitter input has a noise component and wherein the transmit strength estimator comprises:
a transmit input strength estimator configured to calculate a strength of the transmitter input;
a transmit noise strength estimator configured to calculate a strength of the noise component; and
a subtractor configured to calculate a difference between the strength of the transmitter input and the strength of the noise component, wherein the difference is provided as the transmit data strength.

14. The apparatus of claim 11, further comprising:
a transmit switch configured to receive a transmit output control and the transmitter input and to generate a transmitter output based at least in part on the transmitter input and the transmit output control;
a receive switch configured to receive a receive output control and the receiver input and to generate a receiver output based at least in part on the receiver input and the receive output control,
wherein the controller is further configured to generate the transmit output control to control the transmit switch to substantially attenuate the transmit input and to generate the receive output control signal to control the receive switch to substantially attenuate the receive input, if the transmit data strength and the receive data strength are both substantially equal to zero.

15. The apparatus of claim 11, wherein the receive strength estimator further comprises:
a receive noise estimator configured to extract a noise component of the receiver input, wherein extracting the noise component comprises determining a minimum value of the receive input signal during a specified time period, and
a subtractor configured to determine a difference between the receiver input and the noise component of the receiver input, wherein the difference is provided as the receive data strength.

16. A method for comparing signal strength in a speakerphone system, comprising:
determining a transmit data strength signal component of a transmit input signal;
determining a receive data strength signal component of a receive input signal;
comparing the transmit data strength signal component and the receive data strength signal component;
adjusting the determining of the transmit data strength signal component and the receive data strength signal component based at least in part on the comparison;
selectively providing a transmit output signal based at least in part on the comparison, wherein the transmit output signal is based at least in part on the transmit input signal; and
selectively providing a receive output signal based at least in part on the comparison, wherein the receive output signal is based at least in part on the receive input signal.

17. The method of claim 16, wherein the transmit input signal has a data component and a noise component and wherein the determined transmit data strength signal component is based at least in part on the data component.

18. The method of claim 16, wherein the receive input signal has a data component and a noise component and wherein determining the receive data strength signal comprises subtracting the noise component from the receive input signal.

19. The method of claim 16, wherein the transmit input signal has a data component and a noise component and wherein determining the transmit data strength signal component comprises:
calculating a strength of the transmit input signal;
calculating a strength of the noise component of the transmit input signal; and
calculating a difference between the strength of the transmit input signal and the strength of the noise component, wherein the difference is provided as the transmit data strength signal component.

20. The method of claim 16, wherein determining the receive data strength signal component comprises:
determining a noise component of the receive input signal by determining a minimum value of the receive input signal during a specified time period;
determining a difference between the receive input signal and the noise component, wherein the difference is provided as the receive data strength signal component.
